(19) United States
(12) Patent Application Publication
(10) Pub. No.: US 2014/0289134 A1
(43) Pub. Date: Sep. 25, 2014

(54) METHOD AND SYSTEM FOR MANAGING CONTENT FOR AN ELECTRONIC COLLABORATION TOOL

(71) Applicant: Lee Anthony SUTTON, Montreal (CA)

(72) Inventor: Lee Anthony SUTTON, Montreal (CA)

(73) Assignee: Adobe Systems Incorporated, San Jose, CA (US)

(21) Appl. No.: 12/823,465

(22) Filed: Jun. 25, 2010

(51) Int. Cl. G06Q 10/00; G06F 15/16

(52) U.S. Cl. 705/300; 709/206

(57) ABSTRACT

A method of managing content is disclosed. Data which is associated with an activity of a business process is obtained. Said activity is external to an automated business process of an electronic collaboration tool. The automated business process corresponds to the business process. It is determined if the data has a unique identifier associated therewith, indicative of the automated business process. The data is associated in a computer memory device with the automated business process if the data has the unique identifier associated therewith.

### FIELD

The invention pertains to electronic collaboration tools, and more specifically to methods and systems for managing content for an electronic collaboration tool configured to automate a business process.

### BACKGROUND

The continued growth of electronic computing and communication devices throughout the world has created ever expanding opportunities for people to incorporate computing based solutions into their everyday business, government, medical, consumer, and personal activities. Individuals and groups can communicate and collaborate more quickly and effectively using technologies such as voicemail, email, text messaging, word processing, cellular telephones, voice-over-IP, instant messaging, and video conferencing. Electronic files are readily shared electronically as attachments or posted on networks in shared file directories or made available for downloading. The above-noted communication tools provide flexibility and can speed up the movement of information between people.

More recently, electronic collaboration tools allowing people to take advantage of our increasingly networked world by automating business processes have been developed. For example, a driver who has been involved in an auto accident will need to contact an insurance agent to report the accident. The agent will need to look-up the driver's records and initiate an accident report. The automobile may need to be taken to a repair shop, and associated claim forms will need to be filled out. Many people will need to communicate with each other during this process, and records will need to be coordinated along the way. To facilitate processes like this, electronic collaboration tools such as, but not limited to, the Adobe® LiveCycle® solution, enable companies, such as the insurance company in the example, to automate the business process surrounding the accident claim process. As just one example, an automated business process could be set up so that the driver could use a smartphone to log-in to a claim website which could be configured to prompt the driver to capture and upload some accident scene photos, automatically collect a GPS location of the accident, automatically dispatch a tow truck to the accident location, automatically reserve a rental car for the driver, automatically generate an accident claim report that is linked to the information and photos submitted by the driver, and route the information stored as part of this automated business process to an insurance agent for on-line review and approval of the accident claim as part of the automated business process. Such electronic collaboration tools save time, help reduce costs, and provide a streamlined customer and/or user experience which aids in the improvement of overall satisfaction and productivity.

While many businesses and organizations benefit from electronic collaboration tools which are configured to automate business processes, the automated processes are only useful for interacting with and storing data and communications which are within the confines of the predefined automated process. Unfortunately, the same electronic communication tools which enable people to connect and interact with the automated business process are often used outside of the automated business process to communicate information which is relevant to the business process. Such information can be lost or forgotten over time despite its potential value in supporting the business process. For example, in keeping with the auto accident scenario, while an electronic collaboration tool for automating the insurance claim process can be quite helpful, many other communications or information relevant to the auto accident may take place outside of the automated business process. The insurance agent reviewing the claim could decide that an additional picture might be helpful in resolving the insurance claim. The agent might email or call the driver or the auto repair shop for more information. In response, the driver or repair shop could provide further information in an email and/or attach an additional picture to help the process along. Other types of communications, such as voicemails or text messages could also be exchanged during the follow-up with the driver. Unfortunately, data generated from communications like these or other activities outside of the predefined automated business process often are relevant to the business process but are frequently not captured as part of the business process.

### SUMMARY

A method of managing content is disclosed. Data which is associated with an activity of a business process is obtained. Said activity is external to an automated business process of an electronic collaboration tool. The automated business process corresponds to the business process. It is determined if the data has a unique identifier associated therewith, indicative of the automated business process. The data is associated in a computer memory device with the automated business process if the data has the unique identifier associated therewith.

A content management system is also disclosed. The content management system has an electronic collaboration tool configured to automate a business process. The content management system also has a computing device. The computing device is configured to obtain data associated with an activity of the business process wherein said activity is external to an automated business process of the electronic collaboration tool, said automated business process corresponding to said business process. The computing device is also configured to make the obtained data available to the electronic collaboration tool for association with the automated business process.

A computer program product for managing content for an electronic collaboration tool configured to automate a business process is also disclosed. The computer program product includes a tangible storage medium readable by a processor and storing instructions for execution by the processor for performing a method, the method comprising: obtaining data which is associated with an activity of the business process, wherein said activity is external to an automated business process of the electronic collaboration tool, said automated business process corresponding to said business process; determining if the data has a unique identifier associated therewith, indicative of the automated business process; and associating the data in a computer memory device with the automated business process if the data has the unique identifier associated therewith.

### BRIEF DESCRIPTION OF THE DRAWINGS

FIG. 1 is a flow chart of a method of managing content for an electronic collaboration tool configured to automate a business process, according to some embodiments.

FIG. 2 schematically illustrates a content management system according to some embodiments.

FIG. 3 schematically illustrates a content management system according to other embodiments.

FIG. 4 schematically illustrates a content management system according to further embodiments.

FIG. 5 illustrates one example of a method of managing content for an electronic collaboration tool.

FIG. 6 illustrates one example of a method and system for managing content for an electronic collaboration tool configured to automate a managed review and approval process, according to some embodiments.

It will be appreciated that for purposes of clarity and where deemed appropriate, reference numerals have been repeated in the figures to indicate corresponding features. While the system and method for managing content for an electronic collaboration tool are described herein by way of example for several embodiments and illustrative drawings, those skilled in the art will recognize that the system and method for managing content for an electronic collaboration tool are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Various embodiments of a method and system managing content for an electronic collaboration tool are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a computer memory device of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming data, typically represented as physical electronic or magnetic quantities within memories, registers, or other information storage devices, transmission devices, or display devices of the special purpose computer or similar special purpose electronic computing device.

Various portions of this description may reference the encryption or partial encryption of data. In various embodiments, such encryption may include performing any of a variety of encryption algorithms or methods including but not limited to algorithms or methods for symmetric key encryption, algorithms or methods for public key encryption, and/or techniques for some other type of encryption, whether presently known or developed in the future.

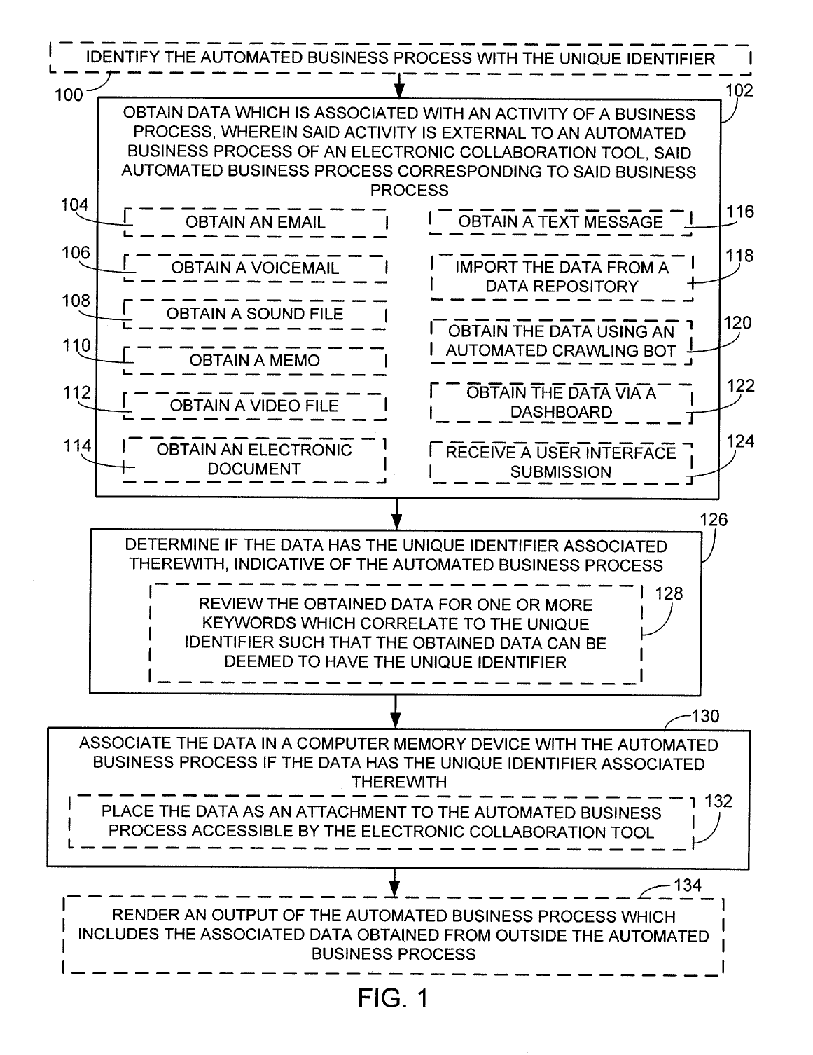

FIG. 1 illustrates a method of managing content for an electronic collaboration tool configured to automate a business process, according to some embodiments. A business process is a set of steps which requires a plurality of collaborative actions from one or more users which assists in developing work product or a decision. Non-limiting examples of business processes may include a loan application and approval process, an insurance claim application and approval process, a benefits application and approval process, a storefront advertising and sales process, a contracts drafting and approval process, a customer service process, a customer troubleshooting process, a project planning and tracking process, a production quality control process, a banking process, an architectural drawing generation and approval process, an academic application and approval process, and a prospective employee screening and interview process.

An electronic collaboration tool may be used to automate a business process. As just one example, an electronic collaboration tool may be configured to present appropriate electronic forms to a bank customer applying for a loan. The electronic collaboration tool in this example may also be configured to collect scanned copies of tax returns and pay stubs. The electronic collaboration tool may be configured to route copies of the collected documents and forms to a loan specialist for initial review and to a bank manager for final approval. Along the way, the electronic collaboration tool may be configured to provide feedback on the application status to the applicant. The electronic collaboration tool may be a pre-configured solution or a customizable solution. Non-limiting examples of electronic collaboration tools include solutions implemented with Adobe® LiveCycle®, WebOrb, Granite, OpenAMF, and WebSphere.

In general, an electronic collaboration tool may be configured to automate certain aspects of a business process in order to help produce work product or a decision. Therefore, the aspect of the business process facilitated by an electronic collaboration tool may be considered an automated business process. As also pointed out in previous examples, the overall business process often encompasses more communications and activities than are included in the automated business process. In the current loan application example, it may be common practice for a loan officer to call or email the applicant, from a device or account which is separate from the electronic collaboration tool, in order to ask for an explanation of spending habits. These separate communications can result in data which is outside the automated business process and therefore not tracked by the electronic collaboration tool. The embodied method, as illustrated in FIG. 1, of managing content for an electronic collaboration tool overcomes these shortcomings.

Optionally, the business process may be identified with a unique identifier at step 100. This action is optional from the point of view of the method of managing content for the electronic collaboration tool because the electronic collaboration tool may already have assigned a unique identifier to a particular business process. For example, a particular loan application being filled out and reviewed for approval may already be assigned a tracking identifier which is unique. If needed, however, the business process can be assigned a unique identifier so that it can be identified 100 with that unique identifier. As non-limiting examples, the unique identifier may be a numeric sequence, an alphabetical sequence, a symbolic sequence, or any combination thereof. In some embodiments, the unique identifier may be a memory storage location.

Data associated with an activity of a business process is obtained in step 102. The activity is external to an automated business process of the electronic collaboration tool, but the automated business process corresponds to the business process. Therefore, the data obtained in step 102 is external to the automated business process, but is associated with an activity of the related business process. Data may be obtained in many ways, including, but not limited to obtaining an email in step 104, obtaining a voicemail in step 106, obtaining a sound file in step 108, obtaining a memo in step 110, obtaining a video file in step 112, obtaining an electronic document in step 114, and obtaining a text message in step 116. Non-limiting examples of a memo include a voice memo, a paper memo, and a memo in electronic format. Voice memos may already be in a sound file format, or may have to be sampled or converted to a particular sound file format. Paper memos may include any paper that is scanned, imaged, or otherwise captured into a data format. Paper memos may also include any paper that is obtained using optical character recognition. Some electronic documents may be electronic memos, but other non-limiting examples of electronic documents may include spreadsheets, presentations, web pages, word processing documents, and text files. A computing device may be configured to obtain the different types of data, and the obtained data may be an entire data file or just a portion of a data file, depending on different embodiments and the type of data being obtained. In order to ensure that the computing device is able to obtain data from outside of the automated business process, the computing device may be configured to monitor a “talk-back” electronic mailbox for copies of correspondence sent by participants in the business process when corresponding outside of the automated business process. In such embodiments, the participants can send their emails, voicemails, text messages, and/or data attachments not only to another participant, but they can copy the “talk-back” address in as well. The computing device can then obtain such data that is outside of the automated business process.

In other embodiments, the computing device may import the data from a data repository, in step 118, having a known location that participants can move files into. In further embodiments, the computing device may be configured to obtain the data in step 120 using an automated crawling process or mechanism, such as a crawling bot or a type of spider which looks for the unique identifier. In still further embodiments, the computing device may be configured to obtain the data via a dashboard in step 122. A dashboard is a high-level summary page which is used to monitor a business process. The dash-board itself is often generated by the automated business process for real-time status viewing, but the state of the dashboard is often not captured or stored and therefore snapshots or a time interval recording of a dashboard is often outside of the automated business process. By configuring the computing device to be able to record or take a snapshot of a dashboard state, the high-level conditions present at one or more points in time during the business process may be obtained. In other embodiments, the computing device may be configured to receive a data submission from a user interface in step 124.

Once data external to the automated business process has been obtained in step 102, a determination is made in step 126 to see if the data has a unique identifier associated therewith, indicative of a business process. The unique identifier may be present in many ways in the obtained data. For example, in emails, the unique identifier may be included by the sender in the subject line, as part of the “talk back” delivery address, or in the body of the email. The “talk back” email box can automatically assign the unique identifier. Memos, text messages, and other electronic documents may have the unique identifier located in the body of the text or in a file header. Video files, sound files, and image files may have the unique identifier embedded in the file as a watermark or barcode, or the unique identifier may be in a file header. A submission by user interface may require the user to enter a unique identifier in a data field. Data obtained via a dashboard may have meta data which includes the unique identifier. Other examples of how a unique identifier may be embedded or included with the obtained data will be readily apparent to those skilled in the art and are intended to be included in this disclosure.

In some embodiments, the determination of whether the obtained data has the unique identifier may be carried out by correlation rather than by direct location of the unique identifier. In such embodiments, the obtained data may be reviewed in step 128 for one or more key words which correlate to the unique identifier such that the obtained data can be deemed to have the unique identifier. For example, consider the situation where a loan applicant sends an email to a bank officer outside of the automated business process, but also copies in a “talk back” server. The loan applicant may forget to include, or may not have access to his application's unique identifier. However, the computing device, after examining the content of the email may be able to identify the loan applicant's name and a reference to a particular type of loan. If the identified information, whatever it may be, when compared to the loan application records, is enough to correlate the particular email to a particular loan application that does have a known unique identifier, then the obtained data (the email in this case) can be deemed to have the unique identifier.

If the data has the unique identifier associated therewith, value may then be derived from the process by associating the obtained data in a computer memory device with the automated business process in step 130. By doing this, the data collected and/or generated outside of the automated business process may now be located and reviewed as necessary within the context of a particular business process (as identified by its unique identifier). This has the advantage of increasing the amount of data which is available for audit reviews or other types of analysis of a particular business process. As part of the data associating step 130, some embodiments may place the data as an attachment to the automated business process accessible by the electronic collaboration tool in step 132. Optionally, an output of the automated business process may be rendered, in step 134, which includes the associated data obtained from outside the automated business process. The rendered output may be in a variety of formats, including, but not limited to the Adobe® PDF format.

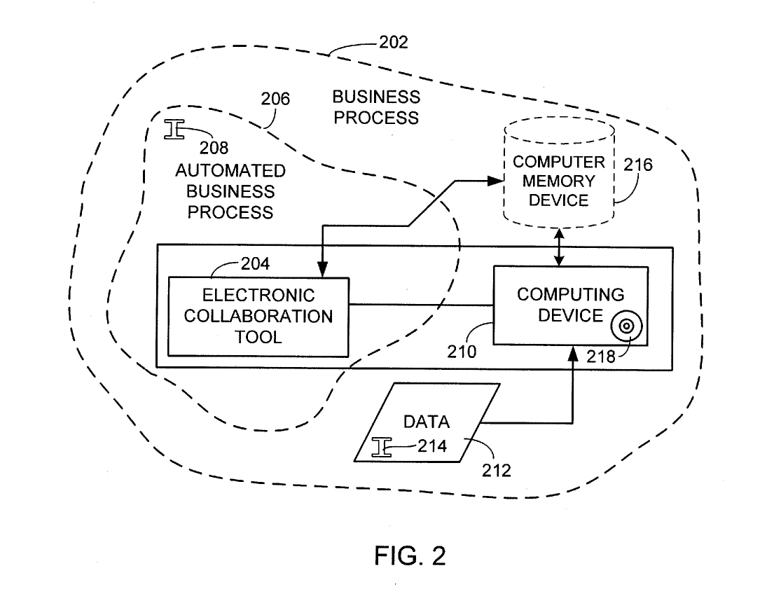

FIG. 2 schematically illustrates a content management system 200 according to some embodiments and for use with a business process 202. The content management system 200 has an electronic collaboration tool 204 that is configured to automate a portion of the business process 202 as automated business process 206. The automated business process 206 is often a subset of the business process 202 since many communications which are part of the business process 202 often occur outside of the automated business process 206. As discussed above, the automated business process 206 is associated with a unique identifier 208. The content management system 200 also includes a computing device 210 which is configured to obtain data 212, related to the business process 202, which is external to the automated business process 206. The computing device 210 is also configured to make the obtained data 212 available to the electronic collaboration tool 204 for association with the automated business process 206. Suitable methods for doing this have been discussed above. For example, the obtained data 212 may be checked for a unique identifier 214. If the computing device 210 determines that the unique identifier 214 of the obtained data matches or is associated with the unique identifier 208 of the business process, then the data 212 obtained external to the automated business process 206 may be passed directly to the electronic collaboration tool 204 for use by the automated business process 206. Alternatively, the computing device 210 may store the data 212 in a computer memory device 216 in such a way that it is associated with the business process by the unique identifier 208, 214. Depending on the embodiment, the data 212 can be, but is not limited to, an email, a voicemail, a text message, a sound file, an image file, a memo, a video file, an electronic document, data imported from a repository (not shown), or data obtained using an automated crawling bot (also not shown). The computing device 210 may be a personal computer, a server, a processor, a mobile computing device, an application specific integrated circuit (ASIC), a field programmable gate array (FPGA), digital circuitry, analog circuitry, or any plurality and/or combination thereof. The computing device 210 may be configured to read a computer program product 218, which may comprise a tangible computer readable storage medium such as, but not limited to a CD-ROM, a DVD, a flash memory, a diskette, a magnetic storage media, an optical storage media, an electronic storage medium, a random access memory (RAM), a read only memory (ROM), and a memory stick. The storage medium is readable by the computing device 210 and stores instructions for execution by the computing device 210 for performing a method of managing content for an electronic collaboration tool 204 as discussed in the embodiments above.

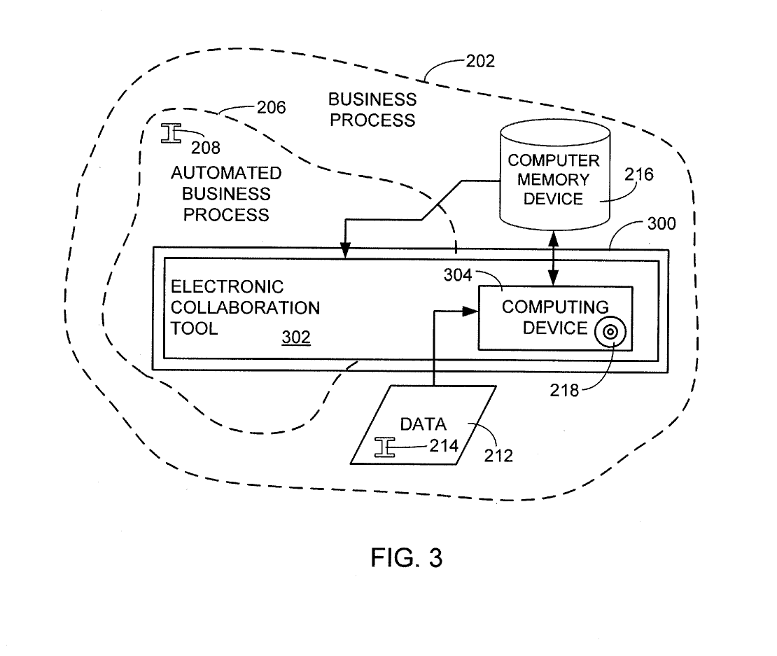

FIG. 3 schematically illustrates a content management system 300 according to other embodiments and for use with a business process 202. The content management system 300 has an electronic collaboration tool 302 that is configured to automate the business process 202. In this embodiment, the electronic collaboration tool 302 includes a computing device 304 which is configured to obtain data 212, related to the business process 202, which is external to the automated business process 206. Since the computing device 304 is part of the electronic collaboration tool 302, the obtained data 212 is also available to the electronic collaboration tool 302 for association with the automated business process 206. Suitable methods for doing this have been discussed above, for example, by comparing the unique identifier 208 of the automated business process 208 with the unique identifier 214 of the obtained data 212. Other aspects can be the same as the embodiment of FIG. 2.

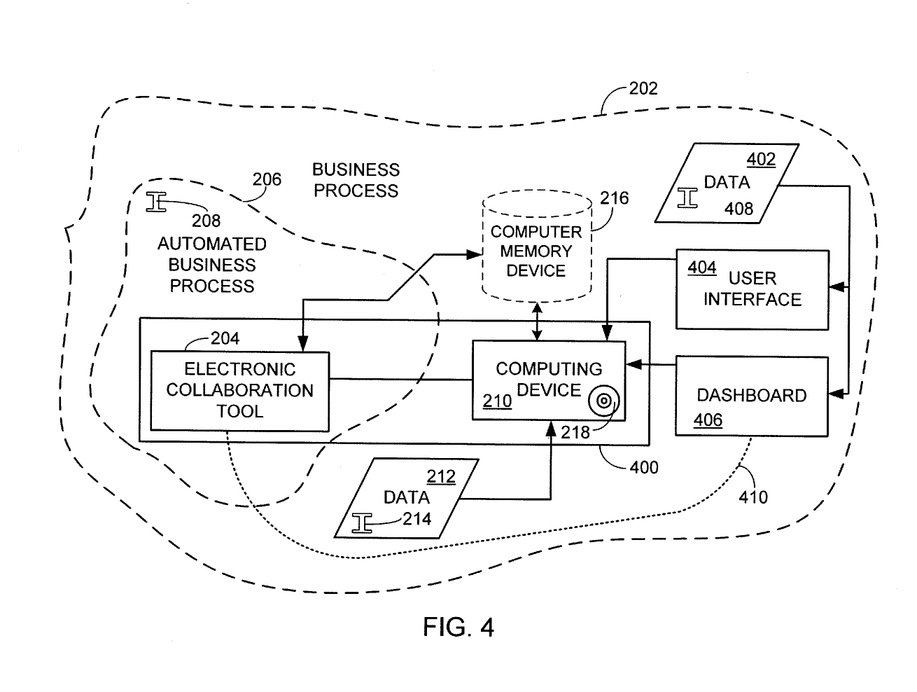

FIG. 4 schematically illustrates a content management system 400 according to further embodiments and for use with a business process 202. The content management system 400 is similar to the content management system 200 of FIG. 2, with some additional features. In this embodiment, the computing device 210 may also obtain data 402 from a user interface 404 or a dashboard 406. The data 402 is related to the business process 202, but external to the automated business process 206. The user interface 404 may be configured to receive the data 402 directly or a reference to a location of the data 402. The data 402 may have a unique identifier 408, which can be used similarly to unique identifier 214 discussed above. The dashboard 406 may be a dashboard provided from a source which is not part of the automated business process 206, or the dashboard may be coupled 410 to the electronic collaboration tool 204. A dashboard 406 is a high-level summary page which is used to monitor a business process. The dash-board 406 itself is often generated by the automated business process for real-time status viewing. By configuring the computing device 210 to be able to record or take a snapshot of a dashboard 406 state, the high-level conditions present at one or more points in time during the business process 202 may be obtained. Other aspects can be the same as the embodiment of FIG. 2.

The computing device 210 is also configured to make the obtained data 212, 402 available to the electronic collaboration tool 204 for association with the automated business process 206. Suitable methods for doing this have been discussed above. Alternatively, the computing device 210 may store the data 212 in a computer memory device 216 in such a way that it is associated with the business process by the unique identifier 208, 214/408. The computing device 210 may be configured to read a computer program product 218, which may comprise a storage medium such as, but not limited to a CD-ROM, a DVD, a flash memory, a diskette, a magnetic storage media, an optical storage media, an electronic storage medium, a random access memory (RAM), a read only memory (ROM), and a memory stick. The storage medium is readable by the computing device 210 and stores instructions for execution by the computing device 210 for performing a method of managing content for an electronic collaboration tool 204 as discussed in the embodiments above.

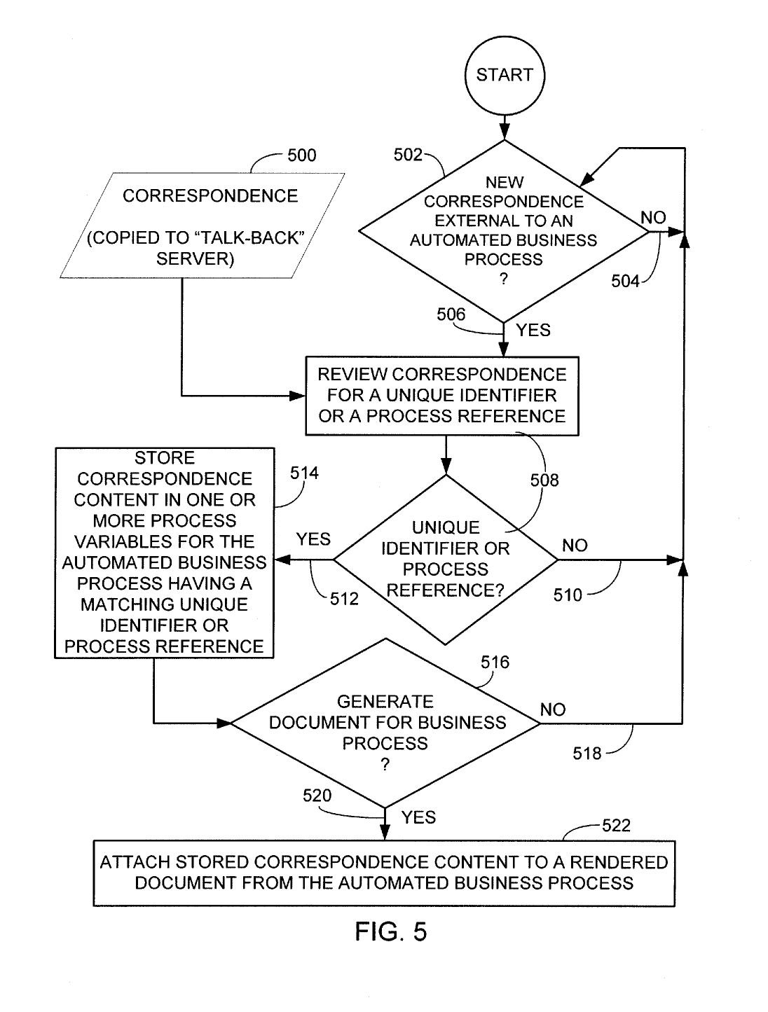

FIG. 5 illustrates one example of a method of managing content for an electronic collaboration tool. The embodied method is useful within a context where the data external to the automated business process includes correspondence 500, such as email, that gets copied or sent to a computing device such as a “talk back” server. Such data is associated with an activity of the business process, wherein said activity is external to the automated business process. The automated business process corresponds to the business process as described above. A check step 502, for example using a computing device, is made to see if there is new correspondence external to an automated business process. If not 504, then the check 502 step can be repeated at a desired interval. If new correspondence has been received (506) from outside of the automated business process, then the correspondence 500 is reviewed, as step 508, for a unique identifier or a process reference which can be correlated to a unique identifier as discussed above. If the correspondence does not have a unique identifier (510) or process reference, then the original check step 502 for new correspondence can be repeated at a desired interval. If the correspondence does have a unique identifier (512) or a process reference that can be correlated to the unique identifier, then content from the correspondence is stored, at step 514, in one or more process variables for the automated business process having a matching unique identifier or process reference. A decision is made, in step 516, as to whether or not it is desired to generate a document for the business process. If it is not desired (518) to generate a document for the business process, then the check step 502 can be repeated at a desired interval. If it is desired (520) to generate a document for the business process, then the stored correspondence content is attached 522 to a rendered document from the automated business process. The rendered document can be a combination of information gathered from within the automated business process and correspondence collected from outside of the automated business process. One suitable, but non-limiting format for the rendered document is the Adobe® PDF format.

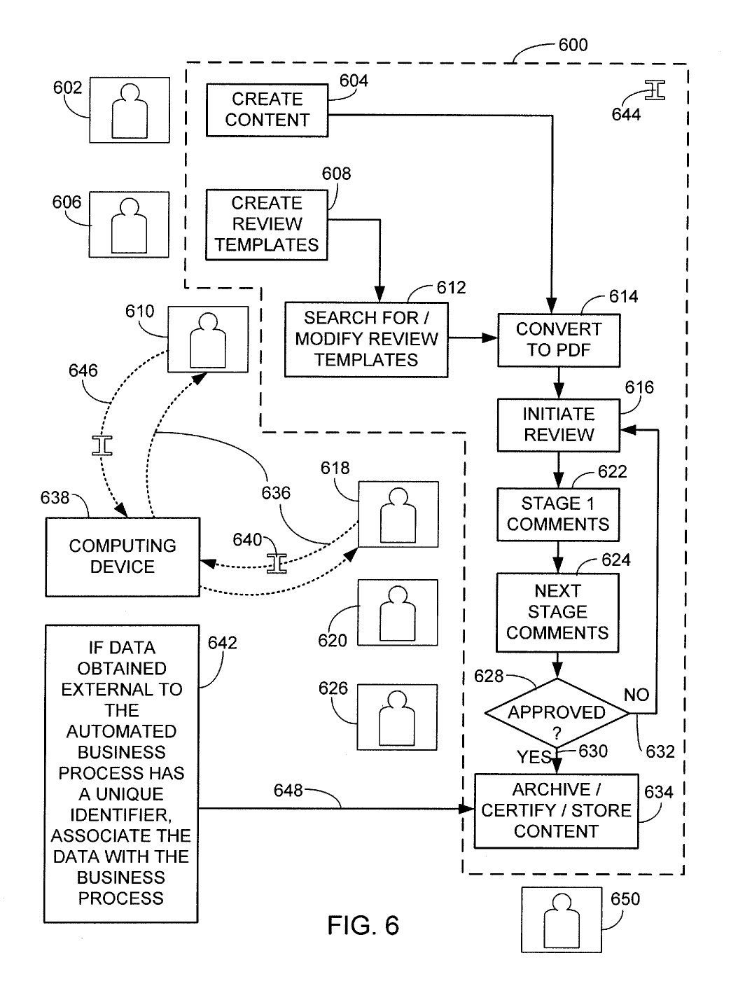

FIG. 6 illustrates one example of a method and system for managing content for an electronic collaboration tool configured to automate a managed review and approval process 600 (a business process), according to some embodiments. In this embodiment, the electronic collaboration tool is configured to allow a content author 602 to create content 604. The content author may be any person who creates or modifies the content that is the subject of review, commenting, and approval within the automated business process 600. In addition to authors, this person can be anyone who creates or submits content that must undergo a review and approval process. The electronic collaboration tool is also configured to allow a process owner or manager 606 to create and review templates 608. The process manager 606 may set up the review templates for each business case; identify review cycles and the business processes that trigger upon review completion; use appropriate standard operating procedures (SOPs) to define review templates; and assist the review process by identifying a group of people who are subject matter experts (SMEs) for the review of a given document type.

The electronic collaboration tool is also configured to allow a review initiator 610 to search for and/or modify 612 an appropriate review template for the process, or this logic may be provided by a separate system or application. Often, the review initiator 610 is the author 602 of the document under review. However, the author 602 and the review initiator 610 are not always the same person. For example, a manager delegates the task of updating a contract to a subordinate. The updated contract is first sent to the manager, who initiates the reviews. Therefore, the review initiator in this case is the manager, and the author may be the subordinate. The review initiator may search for and/or modify 612 an appropriate review template for the process, or this logic may be provided by a separate system or application. The created content in the templates which is provided for review may be converted 614 to a readily viewable format, such as the Adobe® PDF format. The review initiator 610 may also initiate 616 a review process.

In this example, a first stage reviewer 618 and a next stage reviewer 620 review the documents. Other embodiments may use fewer or more reviewers. Reviewers may be subject matter experts (SMEs), who review the document and provide comments if necessary. Depending on the automated business process requirements, the electronic collaboration tool may be configured to allow one or many reviewers to participate in a review stage at the same time. Reviewers may add comments 622, 624 and annotations to the review document, for example, by using the PDF commenting tools in Acrobat or Adobe Reader. Reviewers can be either optional or required. Eventually, the required reviewers determine whether the document proceeds to the next level or whether changes must be made first. Each user has an associated computing device for interfacing the user with the system.

The electronic collaboration tool is also configured to allow one or more approvers 626 to conduct a supervisory analysis of the document. A document is usually submitted for approval 628 after review cycles are completed, though approval stages may also occur between review stages as required. Approvers do not interactively comment on or annotate the content details of documents. They review the document from a high-level point of view, and approve 630 the document or reject 632 the document. An approver may be someone who has already participated in an earlier review stage as a reviewer. If the document is not approved 632, then further review may be initiated. If the document is approved 630, then a variety of actions may take place, including the archiving, certification, and/or storing 634 of the content from the automated business process related to the approval business process.

One suitable, but non-limiting example of an electronic collaboration tool which can be used to implement an automated business process such as the one embodied in FIG. 6 is Adobe LiveCycle® and Adobe's cross-industry managed solutions which are available to support various business processes.

As discussed previously, it is common for communications or other activities to take place outside of the automated business process that are still relevant to the business process. For example, the first stage reviewer 618 could send an email 636 to the review initiator 610 via a computing device 638 such as an email server. Alternatively, the message could be copied to a computing device 638 such as a “talk back” server in addition to sending the email to the review initiator 610. The email could include a unique identifier 640. The computing device 638 may be part of a content management system, such as those described above, which associates 642 data obtained outside a business process (in this case an email 636) with the business process 600 if the unique identifier 640 of the email is associated with a unique identifier 644 for the business process. Many methods of making this association have been discussed above. A similar association can be made for other data external to the automated business process, for example a reply email 646 sent from the review initiator 610 to the first stage reviewer 618.

The associated content 648 from outside of the automated business process may also be archived, certified, and/or stored 634 along with the appropriate content from the automated business process. This is very advantageous because more review information is captured for later review if necessary, for example, by an auditor 650. Auditors may be people who examine the records to assert and confirm that the reviews took place and the approvals were obtained. Auditors can be either internal or external to an organization. Internal auditors may conduct periodic audits to ensure compliance and identify corrective measures if compliance is unsatisfactory. External auditors can do sample audits and issue certification of compliance, file a non-compliance report, or identify areas of improvements. Such auditing processes are made more robust through the use of the claimed invention.

The methods described herein may be implemented in software executed on computer hardware In addition, the order of methods may be changed, and various elements may be added, reordered, combined, omitted, modified, etc. All examples described herein are presented in a non-limiting manner. Various modifications and changes may be made as would be obvious to a person skilled in the art having the benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1-23. (canceled)

24. A method, comprising:
determining, by a processing device, that a first document originated by a first entity requires actions from the first entity and a second entity;
identifying, by the processing device, an automated business process to be executed by an electronic collaboration tool to perform the actions required from the first entity and the second entity;
monitoring, by the processing device, a flow of communications involving at least one of the first entity and the second entity, wherein the flow of communications is performed via an application other than the electronic collaboration tool;
obtaining, by the processing device, a second document from the flow of communications;
determining, by the processing device, that one or more keywords included in the second document are correlated to a unique identifier for the automated business process; and
generating, by the processing device, a reference to the second document in a computer memory device accessible by the electronic collaboration tool in executing the automated business process, wherein the reference includes the unique identifier and is generated based on the second document having the one or more keywords correlated to the unique identifier.

25. The method of claim 24, wherein obtaining the second document from the flow of communications comprises obtaining an email communicated sent by at least one of the first entity and the second entity.

26. The computer program product of claim 34, wherein determining that the one or more keywords included in the second document are correlated to the unique identifier comprises determining that one or more keywords in a subject field of the obtained email are correlated to the unique identifier.

27. The computer program product of claim 34, wherein determining that the one or more keywords included in the second document are correlated to the unique identifier comprises determining that one or more keywords in a body of the obtained email are correlated to the unique identifier.

28. The method of claim 24, wherein obtaining the second document from the flow of communications comprises at least one of:
obtaining a sound file generated by at least one of the first entity and the second entity;
obtaining an image file generated by at least one of the first entity and the second entity;
obtaining an electronic document generated by at least one of the first entity and the second entity;
obtaining a text message sent by at least one of the first entity and the second entity; or
receiving the second document via a graphical interface accessed by at least one of the first entity and the second entity.

29. The method of claim 24, wherein monitoring the flow of communications involving at least one of the first entity and the second entity comprises monitoring a dashboard accessible via the application other than the electronic collaboration tool.

30. The method of claim 24, wherein generating the reference to the second document in the computer memory device accessible by the electronic collaboration tool comprises adding the second document as an attachment to the automated business process, wherein the attachment is accessible by the electronic collaboration tool.

31. The method of claim 24, further comprising rendering, by the processing device, an output of the automated business process which includes the second document.

32. The method of claim 24, wherein the flow of communications does not include transmitting the first document.

33. A computer program product comprising a non-transitory computer-readable medium storing instructions executable by a processing device for performing a method comprising:
determining that a first document originated by a first entity requires actions from the first entity and a second entity;
identifying an automated business process to be executed by an electronic collaboration tool to perform the actions required from the first entity and the second entity;
monitoring a flow of communications involving at least one of the first entity and the second entity, wherein the flow of communications is performed via an application other than the electronic collaboration tool;
obtaining a second document from the flow of communications;
determining that one or more keywords included in the second document are correlated to a unique identifier for the automated business process; and
generating a reference to the second document in a computer memory device accessible by the electronic collaboration tool in executing the automated business process, wherein the reference includes the unique identifier and is generated based on the second document having the one or more keywords correlated to the unique identifier.

34. The computer program product of claim 33, wherein obtaining the second document from the flow of communications comprises obtaining an email communicated sent by at least one of the first entity and the second entity.

35. The computer program product of claim 34, wherein determining that the one or more keywords included in the second document are correlated to the unique identifier comprises determining that one or more keywords in a subject field of the obtained email are correlated to the unique identifier.

36. The computer program product of claim 34, wherein determining that the one or more keywords included in the second document are correlated to the unique identifier comprises determining that one or more keywords in a body of the obtained email are correlated to the unique identifier.

37. The computer program product of claim 33, wherein obtaining the second document from the flow of communications comprises at least one of:
obtaining a sound file generated by at least one of the first entity and the second entity;
obtaining an image file generated by at least one of the first entity and the second entity;
obtaining an electronic document generated by at least one of the first entity and the second entity;
obtaining a text message sent by at least one of the first entity and the second entity; or
receiving the second document via a graphical interface accessed by at least one of the first entity and the second entity.

38. The computer program product of claim 33, wherein monitoring the flow of communications involving at least one of the first entity and the second entity comprises monitoring a dashboard accessible via the application other than the electronic collaboration tool.

39. The computer program product of claim 33, wherein generating the reference to the second document in the computer memory device accessible by the electronic collaboration tool comprises adding the second document as an attachment to the automated business process, wherein the attachment is accessible by the electronic collaboration tool.

40. The computer program product of claim 33, further comprising instructions executable by the processing device for rendering an output of the automated business process which includes the second document.

41. The computer program product of claim 33, wherein determining that the one or more keywords included in the second document are correlated to the unique identifier for the automated business process comprises determining that a combination of keywords included in the second document corresponds to a combination of attributes of the automated business process associated with the unique identifier.

42. A system, comprising:
a non-transitory computer-readable medium;
a processor configured to execute instructions embodied in the non-transitory computer-readable medium to perform operations comprising:
determining that a first document originated by a first entity requires actions from the first entity and a second entity;
identifying an automated business process to be executed by an electronic collaboration tool to perform the actions required from the first entity and the second entity;
monitoring a flow of communications involving at least one of the first entity and the second entity, wherein the flow of communications is performed via an application other than the electronic collaboration tool;
obtaining a second document from the flow of communications;
determining that one or more keywords included in the second document are correlated to a unique identifier for the automated business process; and
generating a reference to the second document in a computer memory device accessible by the electronic collaboration tool in executing the automated business process, wherein the reference includes the unique identifier and is generated based on the second document having the one or more key words correlated to the unique identifier.

43. The system of claim 42, wherein obtaining the second document from the flow of communications comprises obtaining an email communicated sent by at least one of the first entity and the second entity.

44. The system of claim 42, wherein determining that the one or more keywords included in the second document are correlated to the unique identifier for the automated business process comprises determining that a combination of keywords included in the second document corresponds to a combination of attributes of the automated business process associated with the unique identifier.

45. The system of claim 42, wherein the processing device is further configured for executing the electronic collaboration tool embodied in the non-transitory computer-readable medium to render an output of the automated business process which includes the second document.
